(19) United States
(12) Patent Application Publication
(10) Pub. No.: US 2024/0235067 A1
(43) Pub. Date: Jul. 11, 2024

(54) CAM AND BLOCK TAP CONNECTOR

(71) Applicant: Hubbell Incorporated, Shelton, CT (US)

(72) Inventors: Charles L. York, Bow, NH (US); Matthew R. Bednara, Collinsville, IL (US); Ruben S. Fernandez, Chino Hills, CA (US)

(21) Appl. No.: 18/409,909

(22) Filed: Jan. 11, 2024

Related U.S. Application Data
(60) Provisional application No. 63/438,345, filed on Jan. 11, 2023.

(51) Int. Cl. H01R 4/50; H01R 4/2404

(52) U.S. Cl. CPC H01R 4/5008; H01R 4/2404

(57) ABSTRACT

Electrical connector assemblies adapted to electrically and mechanically connect conductors within transmission and/or distribution circuits is provided. A frame has opposing conductor securing contact sections and a cam member is rotatably mounted to the frame between the opposing conductor securing contact sections. A block is provided between the cam member and conductors to be secured in the opposing conductor securing contact sections and when the cam member is rotated, the blocks press against the conductors securing the conductors in the opposing conductor securing contact sections.

### CROSS REFERENCE TO RELATED APPLICATIONS

The present disclosure is based on and claims benefit from co-pending U.S. Provisional Patent Application Ser. No. 63/438,345 filed, Jan. 11, 2023 entitled CAM AND BLOCK TAP CONNECTOR the contents of which are incorporated herein in their entirety by reference.

### BACKGROUND

### Field

The present disclosure relates generally to electrical connectors. More particularly, the present disclosure relates to cam and block tap connectors.

### Description of the Related Art

Wedge type electrical connector assemblies are known in the art. Electrical connectors may be adapted to electrically and mechanically connect conductors within a transmission or distribution circuit. For example, a typical electrical connector may be used to connect a main conductor to a tap conductor. An electrical connector adapted to connect a main conductor or a tap conductor to another conductor may be referred to as a tap connector. Various types of tap connector systems exist including various systems utilizing wedge type connectors. For example, a first wedge type tap connector system includes a C-shaped body having a curved top wall adapted to fit over a main conductor. A bolt-operated wedge is carried by the bottom of the C-shaped body and may include an elongated recess in the top for supporting the tap conductor. A conductor interface has a handle thereon which allows the interface to be placed within the C-shaped connector body between the conductors. A bolt positively moves the wedge both in and out of the C-shaped body so that the clamping action of the connector can be tightened or loosened as desired. A second wedge type tap connector system includes a C-shaped body having a curved top wall adapted to fit over a main conductor and a curved opposing wall adapted to fit over a tap conductor. A wedge is set between the main conductor and tap conductor after they have been positioned within the C-shaped body. A specialized tool is temporarily attached to the C-shaped body. The specialized tool includes a mechanism for firing an explosive charge which drives a movable pin against the wedge forcing the wedge against the two conductors locking them in place in the C-shaped body.

However, the conductor interface used in the first wedge type connector system described above is generally a separate component of such wedge type electrical connector assembly which requires additional steps and care be taken in order to install the wedge type electrical connector assemblies. The explosive charge utilized in the second wedge type connector system described above is generally noisy and messy to operate and requires specialized tools and the use of explosive charges.

### SUMMARY

The present disclosure provides exemplary embodiments of electrical connector assemblies adapted to electrically and mechanically connect conductors within transmission and/or distribution circuits. In an exemplary embodiment, the electrical connector assembly includes a frame having opposing conductor securing contact sections and a cam member rotatably mounted to the frame between the opposing conductor securing contact sections. A block is provided between the cam member and conductors to be secured in the opposing conductor securing contact sections and when the cam member is rotated, the blocks press against the conductors securing the conductors in the opposing conductor securing contact sections.

In another exemplary embodiment, the electrical power connector assembly includes a frame having opposing conductor securing contact sections and a cam member rotatably mounted to the frame between the opposing conductor securing contact sections. The cam member includes contact surfaces for contacting the conductors to be secured in the opposing conductor securing contact sections and when the cam member is rotated, the contact surfaces press against the conductors securing the conductors in the opposing conductor securing contact sections.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1A-1B are perspective views of an electrical cable connector assembly according to an illustrative embodiment of the present disclosure;

FIG. 2A is a cross-sectional view of an electrical cable connector assembly according to an illustrative embodiment of the present disclosure taken along line 2A-2A of FIG. 1B;

FIG. 2B is a cross-sectional view of a portion of an electrical cable connector assembly according to an illustrative embodiment of the present disclosure taken along line 2B-2B of FIG. 2A;

FIGS. 2C, 2D are views of a portion of the electrical cable connector assembly according to illustrative embodiments of the present disclosure;

FIG. 3A-3B are perspective views of the electrical cable connector assembly according to the illustrative embodiment of the present disclosure;

FIG. 4A is a perspective view of the electrical cable connector assembly according to the illustrative embodiment of the present disclosure taken along line 4A-4A of FIG. 3B;

FIG. 4B is a cross-sectional view of a portion of the electrical cable connector assembly according to an illustrative embodiment of the present disclosure taken along line 4B-4B of FIG. 4A;

FIG. 4C is a front view of a cam member according to an illustrative embodiment of the present disclosure;

FIG. 5 is a perspective view of an electrical cable connector assembly according to another illustrative embodiment of the present disclosure;

FIG. 6 is an exploded view of the electrical cable connector assembly according to the illustrative embodiment of the present disclosure depicted in FIG. 5;

FIGS. 7A-7C are views of an electrical cable connector assembly according to another illustrative embodiment of the present disclosure; and

FIGS. 8A and 8B are views of portions of electrical cable connector assemblies according to other illustrative embodiments of the present disclosure.

### DETAILED DESCRIPTION

The present disclosure provides exemplary embodiments of improved electrical cable connectors adapted to electrically and mechanically connect conductors within transmission or distribution circuits. The electrical cable connectors contemplated by the present disclosure include, but are not limited to, tap connectors. Tap connectors electrically and mechanically connect a main conductor to a tap conductor. The electrical cable connector according to an illustrative embodiment of the present disclosure includes one or more cam members mounted to a C-shaped body. When rotated, the cam member(s) urge the main conductor and the tap conductor into the C-shaped body securing them in place. One or more conductor blocks or interfaces may be provided between the cam members and the main conductor and the tap conductor. For ease of description, the electrical cable connectors contemplated by the present disclosure may also be referred to herein as the “connectors” in the plural and the “connector” in the singular. The conductor interfaces and blocks contemplated by the present disclosure may also be referred to herein as the “interfaces” and “blocks” in the plural and the “interface” and the “block” in the singular. The cam members contemplated by the present disclosure may also be referred to herein as the “cam members” in the plural and the “cam member” in the singular. The main conductors referenced herein include, for example, transmission line conductors, and the tap conductors referenced herein include, for example, branch conductors. For general reference purposes, a main conductor supplies power from either a transmission circuit or a distribution circuit, and a tap conductor distributes power to a distribution circuit or a load. The conductors or cables referenced herein may include single strand or multi strand cables which may or may not be encased in an insulating jacket or have one or more insulating coatings. Reference to stripped conductors or cables refers to portions of the conductors or cables not having the insulating jacket or coatings as well as those cables not having any form of insulating jacket and/or coatings.

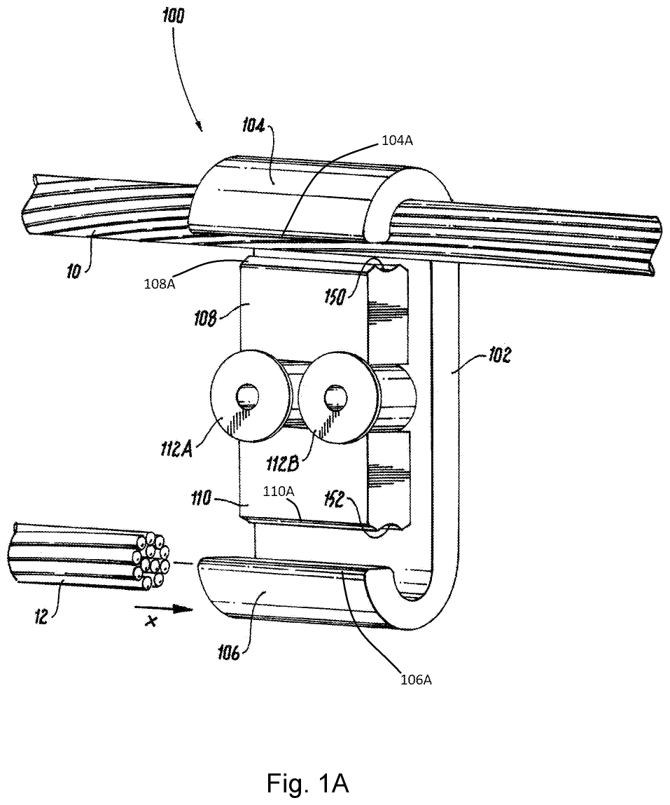

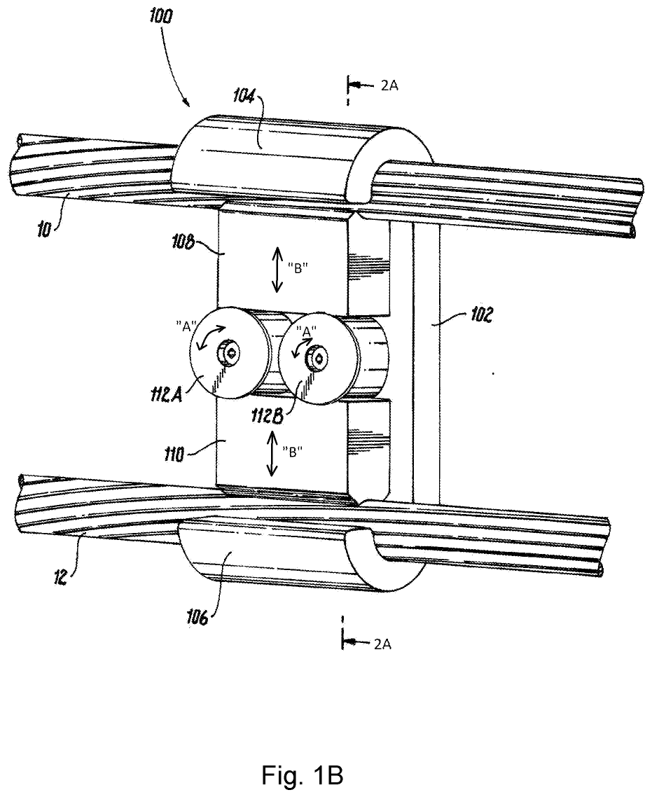

An electrical cable connector according to an illustrative embodiment of the present disclosure is shown in FIGS. 1A-1B and may be referred to generally as cable connector or connector 100. Connector 100 is used to electrically and mechanically connect a plurality of conductors such as a main conductor 10 a tap conductor 12. Connector 100 includes a C-shaped frame 102, blocks 108, 110 and one or more cam members 112A, 112B. The C-shaped frame 102 has an upper channel 104 and a lower channel 106. Upper channel 104 and lower channel 106 of the C-shaped frame 102 are provided for receiving stripped conductors 10 and 12, respectively, which are to be electrically and mechanically connected. In particular, upper channel 104 and lower channel 106 are dimensioned to correspond to a shape and diameter of the stripped conductors 10, 12. The one or more cam members 112A, 112B are rotatably mounted to C-shaped frame 102 and are rotatable in the directions indicated by arrows “A”. In particular, the axis of rotation of cam members 112A, 112B is generally perpendicular to the upper channel 104 and lower channel 106. A portion of blocks 108, 110 abut cam members 112A, 112B and are movable within C-shaped frame 102 in the directions indicated by arrows “B”. In particular, as cam members 112A, 112B are rotated in a clockwise or counterclockwise direction “A”, blocks 108, 110 ride along the cam surfaces of cam members 112A, 112B such that block 108 is urged upward and block 110 is urged downward in the view depicted in FIG. 1B. Blocks 108, 110 press and secure cables 10, 12, respectively, which are positioned within the upper channel 104 and the lower channel 106.

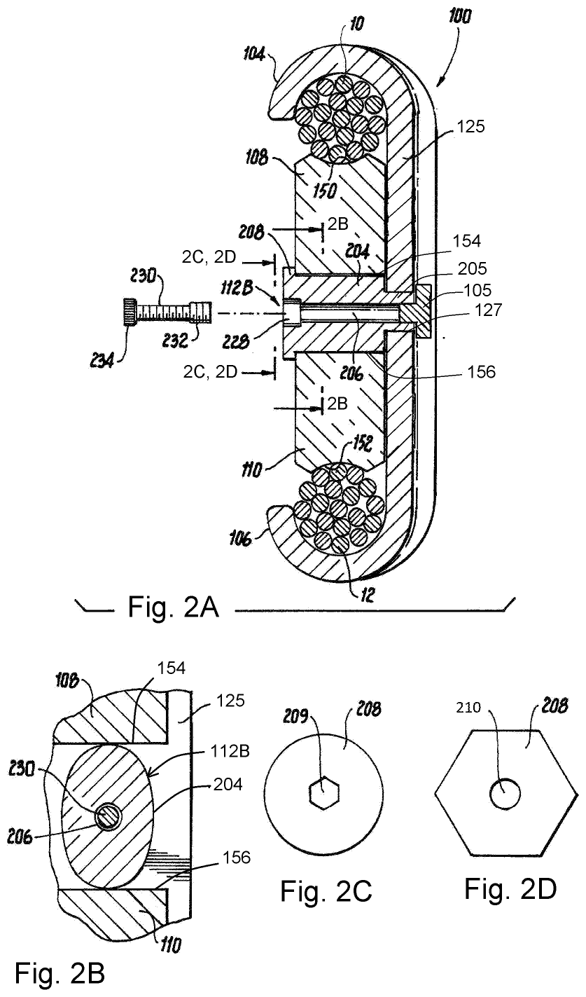

As depicted in FIG. 2A, each cam member 112A, 112B is rotatably mounted next to each other and generally along the middle portion of the rear surface 125 of C-shaped frame 102. Blocks 108, 110 include cable contact surfaces 150, 152, respectively which may be arcuate surfaces in the form of an elongated recess or groove. The cable contact surfaces 150, 152 are preferably configured and dimensioned to contact with stripped conductors 10, 12 positioned in the upper and lower channels 104, 106, respectively of C-shaped frame 102. In particular, the elongated recess or grooves may be shaped and dimensioned to correspond to a shape and diameter of the stripped conductors 10, 12. For example, according to the present illustrative embodiment, the cable contact surfaces 150, 152 are arcuate recesses or grooves and have a diameter substantially similar to a diameter of the stripped conductors 10, 12. Blocks 108, 110 also include cam contact surfaces 154, 156 which bear against cam members 112A, 112B.

Prior to cam members 112A, 112B being rotated, a stripped distal end portion of cable 12 may be inserted in direction “X” into lower channel 106 as shown in FIG. 1A-1B and positioned between lower channel 106 and lower block 110. A gap is formed between the tip 106A of lower channel 106 and the outside edge 110A of lower block 110 which may be slightly larger than a diameter of the cable being connected. Accordingly, if the connection is being made in a mid-run portion of a run of cable 12, the stripped portion of cable 12 may be laid parallel to that gap and the cable 23 slid into the gap and positioned between lower channel 106 and lower block 110 prior to cam members 112A, 112B being rotated. A stripped portion of cable 10 may be inserted and positioned between upper channel 104 and upper block 108 similar to that described above with respect to lower channel 106. The gap formed between the tip 104A of upper channel 104 and the outside edge 108A of upper block 108 may also be slightly larger than a diameter of the cable being connected. Accordingly, if the connection is being made in a mid-run portion of a run of cable 10 as depicted in FIG. 1A-1B, the stripped portion of cable 10 may be laid parallel to that gap and the cable 10 slid into the gap and positioned between upper channel 104 and upper block 108 prior to the cam members 112A, 112B being rotated.

Cam members 112A, 112B may be configured in any manner suitable to urging the blocks 108, 110 to move (e.g., up and down as depicted in FIG. 1A) when cam members 112A, 112B are rotated about an axis formed by screw or bolt 230. According to the illustrative embodiment depicted in FIG. 2A, cam members 112A, 112B include a head 208 and a main body or shank 204. At least a portion of main body or shank 204 of cam members 112A, 112B is generally oblong in cross-section as shown in FIG. 2B, deviating in length in at least one direction. Cam members 112A, 112B having cross-sectional shapes other than oblong are contemplated, as long as it results in the blocks 108, 110 being urged in the direction of the upper and lower channels 104, 106 when the cam member or members are rotated in a direction transverse to those channels. In FIG. 2B, cam member 112B is depicted in the extended position with the longest length cross-sectional portion extending vertically. This may be referred to herein as a compressive position. When cam member 112B is rotated such that the longest length cross-sectional portion extends horizontally, this may be referred to herein as a release position. The cam contact surfaces 154, 156 of blocks 108, 110 bear against the main bodies or shanks 204 of cam members 112A, 112B as cam members 112A, 112B are rotated between the compressive position and the release position. Cam members 112A, 112B each have an orifice 206 extending therethrough which is dimensioned to receive a shank 232 of mounting screw or bolt 230. A slightly larger orifice 228 may be provided closest to head 208 and dimensioned to receive and countersink head 234 of mounting bolt 230. The distal end portions 205 of cam members 112A, 112B include an extension 205 dimensioned to be rotatably received in a bore 127 in the rear surface 125 of C-shaped frame 100. Head 208 of cam members 112A, 112B may be configured in various ways depending on a particular embodiment. For example, according to the illustrative embodiment depicted in FIG. 2C, head 208 may be round and have a hex hole 209 provided therein. Hex hole 209 is large enough to allow passage of bolt 230 and allows the head 234 of bolt 230 to be countersunk within hex hole 209 so that hex hole 209 can receive a hex driver or Allen wrench which can be used to rotate the cam members 112A, 112B. According to another illustrative embodiment of the present disclosure, head 208 may generally be in any suitable shape allowing various types and sizes of tools to be used to rotate head 208. For example, according to the embodiment depicted in FIG. 2D, head 208 may be hexagonal in shape and includes an orifice 210 therethrough for receiving bolt 230. Hexagonal head 208 may be dimensioned such that a socket wrench, box wrench, open end wrench, etc. may be used to rotate the cam members 112A, 112B. Of course, it will be appreciated the hexagonal shaped head 208 as depicted in FIG. 2D may be provided with a hex hole similar to that depicted in FIG. 2C. Bolt 230 includes threads 232 which allow bolt 230 to be screwed into a corresponding threaded orifice (not shown) in the rear surface 125 of C-shaped frame 102. Alternatively, bolt 230 may extend through an orifice 127 in C-shaped frame 102 and threads 232 of bolt 230 screwed into nut 105 securing cam members 112A, 112B to C-shaped frame 102.

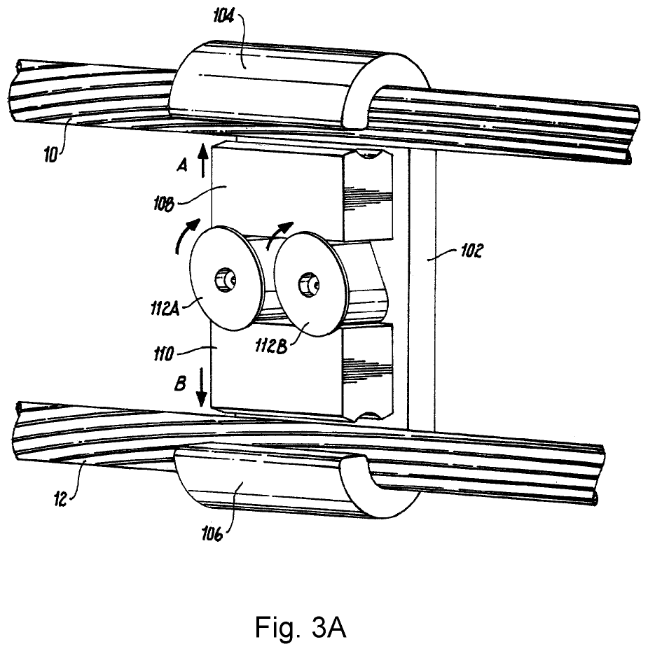

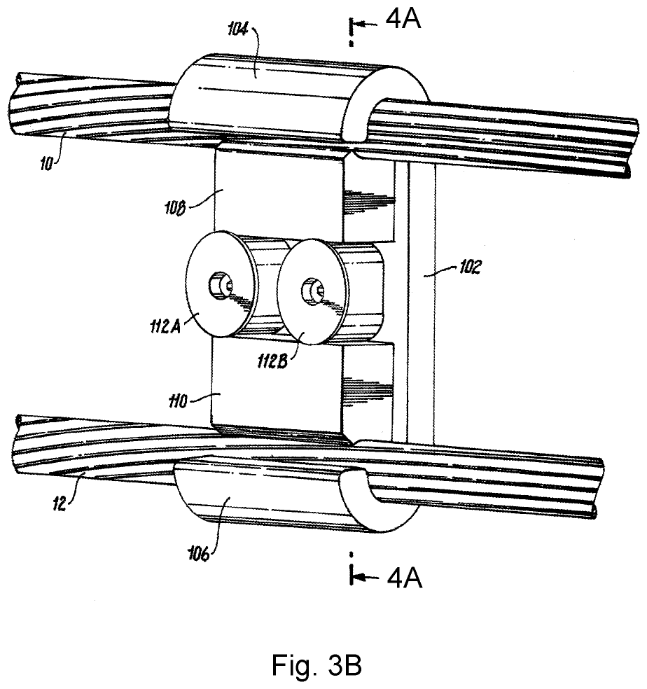

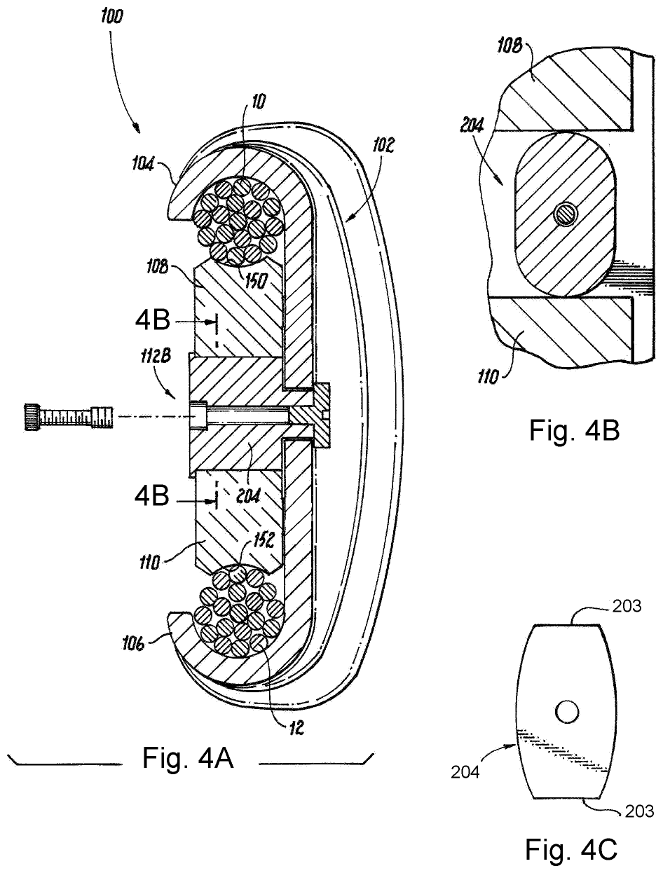

Referring to FIG. 3A. to electrically and mechanically connect cables 10 and 12, cam members 112A, 112B are rotated until cam surfaces are in the release position. Cable 10 is then situated within upper channel 104 and cable 12 is situated within lower channel 106. Blocks 108, 110 are positioned between cam members 112A, 112B and cables 10, 12 as shown. Cam members 112A, 112B are then rotated. Blocks 108, 110 ride along surfaces of cam members 112A, 112B urging blocks 108, 110 in directions “A” and “B”, respectively until the cam surfaces of cam members 112A, 112B are in the vertical compressive positions (FIG. 3B). In particular, cams 112A, 112B are rotated until the oblong shafts 204 of cams 112A, 112B are positioned vertically (e.g., see FIG. 4B). In this position, block 108 thus presses cable 10 into upper channel 104. Block 110 presses cable 12 into lower channel 106. In this position, cables 10, 12 will be fully compressed within C-shaped frame 102 so that they are effectively mechanically and electrically connected.

As noted above, cam members 112A, 112B may be configured in any manner suitable to allowing the blocks 108, 110 to be moved up and down when cam members 112A, 112B are rotated. In addition, according to an illustrative embodiment of the present enclosure as shown in FIG. 4C, shank 204 of cam members 112A, 112B may also include flat surfaces 203 which act as detents so that as the cam members are rotated, they will effectively stay in place when they are rotated to the compressive positions. In this position, the blocks 108, 110 will rest on the flat surfaces 203 of the shank 204 and will remain in place until the cam members are rotated out of this compressive position.

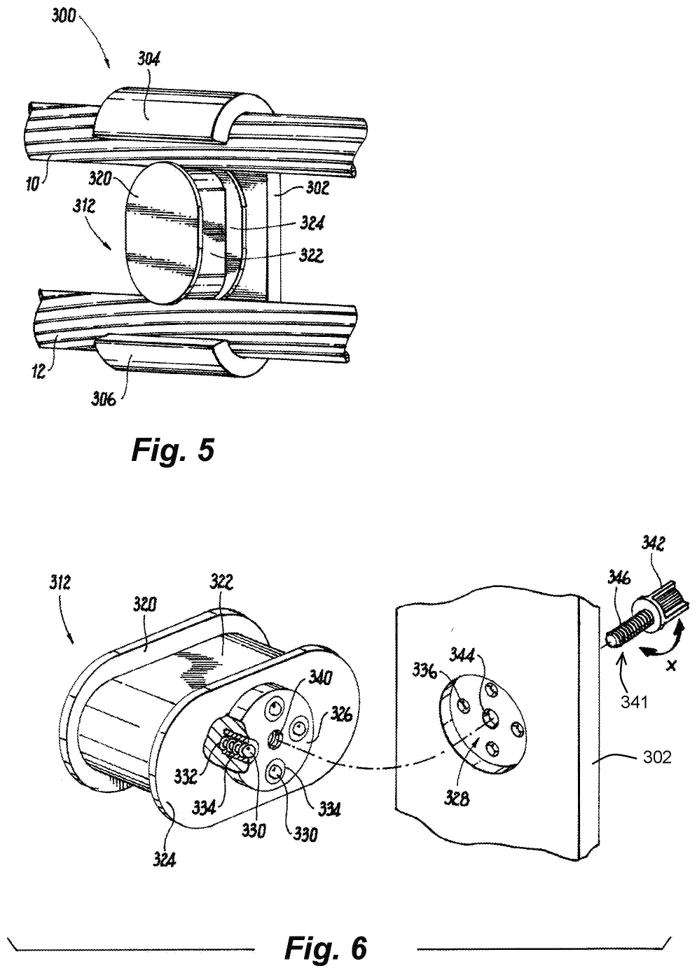

An electrical cable connector according to another illustrative embodiment of the present disclosure is shown in FIGS. 5 and 6 and may be referred to generally as cable connector or connector 300. Connector 300 includes a generally C-shaped frame 302 having an upper channel 304 and a lower channel 306. Upper channel 304 and lower channel 306 are dimensioned for receiving stripped cables which are to be electrically and mechanically connected. Connector 300 also includes one or more cam members 312 rotatably mounted generally along the middle portion of C-shaped frame 302. Cam member 312 includes a face 320, a shank or main body 322 and a base 324. At least a portion of main body 322 is oblong in cross-section. The lower surface of base 324 includes a round extension 326 which is dimensioned to fit in circular recess 328 in C-shaped frame 302. The lower surface of the round extension 326 includes one or more (in this embodiment 4) holes 334. One or more of the holes 334 has a ball 330 biased outwardly by a spring 332. A diameter of the opening of hole 334 may be dimensioned slightly smaller than a diameter of the ball, keeping the ball 330 in position such that only a portion of the ball 330 extends past the lower surface of round extension 326. The lower surface of circular recess 328 includes one or more round indentations or notches 336 (in this embodiment 4) which correspond in dimension and position to receive the ball(s) 330 as main body 322 is rotated. A screw 341 including a head 342 has a threaded shaft 346 which extends through a hole 344 in the center of circular recess 328 and is screwed into the corresponding threaded hole 340 in main body 322 of cam member 312. Cam member 312 is thus rotatable about an axis of rotation formed by screw 341 in the “X” directions as desired. The spring biased balls 330 and notches 336 act as detents allowing the cam member 312 to be maintained in one or more positions. Cam member 312 can be rotated using screw head 342. Alternatively, face 320 of cam member 312 may include a hexagonal opening 209 as depicted in FIG. 2C and/or a raised hexagonal surface 208 as depicted in FIG. 2D allowing wrenches to be used for rotating cam member 312. According to this embodiment, the main body 322 of cam member 312 contacts cables 10 and 12 directly, urging and pressing the cables into upper channel 304 and lower channel 306, respectively. According to alternate embodiments, it will be appreciated that one or more blocks similar to blocks 108, 110 as described with respect to earlier embodiments may be provided between cam member 312 and cables 10, 12 positioned in the upper channel 304 and the lower channel 306 of generally C-shaped frame 302 for electrically and mechanically connecting two or more cables as described in previous embodiments.

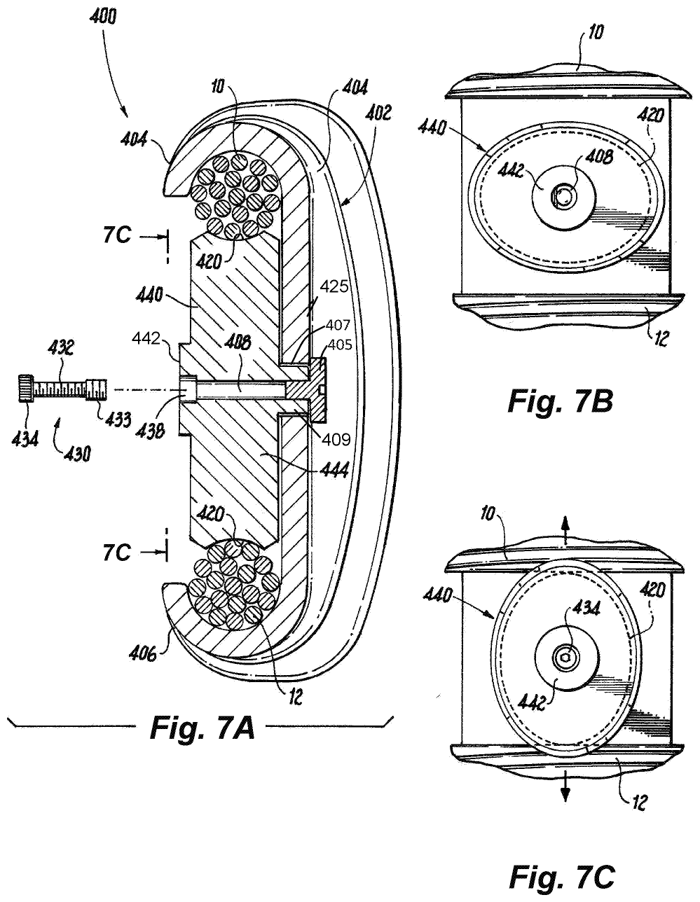

An electrical cable connector according to another illustrative embodiment of the present disclosure is shown in FIGS. 7A-7C and may be referred to generally as cable connector or connector 400. Connector 400 includes a generally C-shaped frame 402 having an upper channel 404 and a lower channel 406. Upper channel 404 and lower channel 406 are dimensioned for receiving stripped cables 10 and 12, respectively, which are to be electrically and mechanically connected. Connector 400 also includes one or more cam members 440 rotatably mounted generally along the middle portion of C-shaped frame 402. The distal end portions of cam member 440 include an extension 409 dimensioned to be rotatably received in a bore 407 in the rear surface 425 of C-shaped frame 100. According to the illustrative embodiment, cam member 440 includes a head 442 and a shank 444. At least a portion of shank 444 is generally oblong in cross-section as shown in FIG. 7B, 7C. Cam member 440 has an orifice 408 extending therethrough which is dimensioned to receive a shank 432 of mounting screw or bolt 430. A slightly larger orifice 438 is provided closest to head 442 and is dimensioned to receive and countersink head 434 of mounting bolt 430. Head 442 may be configured in various ways depending on a particular embodiment. For example, head 442 may be round and have a hex hole provided therein as described above with respect to FIG. 2C. The hex hole is large enough to allow passage of bolt 430 and is dimensioned to receive a hex driver or Allen wrench which can be used to rotate the cam member 440. According to another illustrative embodiment of the present disclosure, head 442 is generally hexagonal in shape similar to that as described above with respect to FIG. 2D and includes an orifice therethrough for receiving bolt 430. The hexagonal head may be dimensioned such that a socket wrench, box wrench, open end wrench, etc. may be used to rotate the cam member 440. Bolt 430 includes threads 433 which allow bolt 430 to be screwed into a corresponding threaded orifice (not shown) in C-shaped frame 402. Alternatively, bolt 430 may extend through an orifice 407 in C-shape frame 402 and be rotatably attached thereto by a nut 405.

According to the present illustrative embodiment, separate blocks are not utilized between cam member 440 and cables 10, 12. Instead, cam member 440 includes a groove 420 extending at least part way around the outer edge thereof. Cam member 440 and groove 420 are dimensioned such that when cam is in the position shown in FIG. 7B, cables 10, 12 can be easily positioned within C-shaped frame 402. For example, the diameter of the groove 420 may be substantially similar to a diameter of the stripped cables 10, 12. When cam member 440 is rotated to the compressive position shown in FIG. 7C, cam member 440 compresses cable 10 against upper channel 404 and cable 12 against lower channel 406 providing mechanical and electrical connection of the cables.

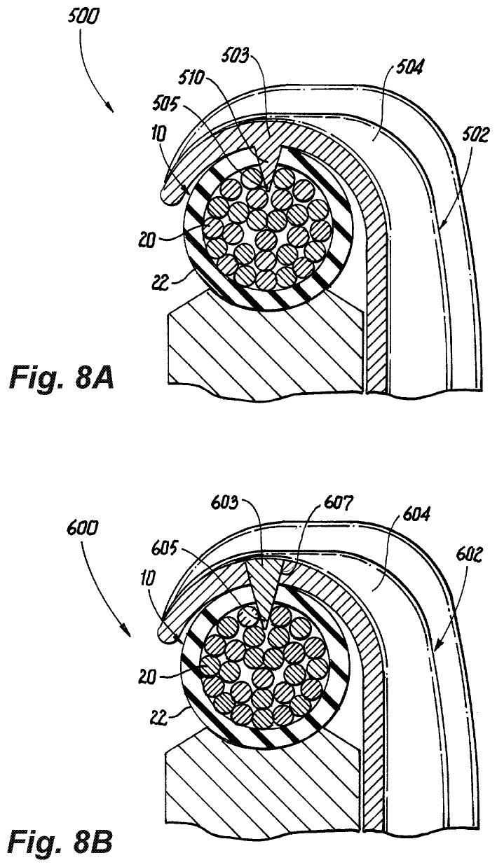

An electrical cable connector according to another illustrative embodiment of the present disclosure is shown in FIG. 8A and may be referred to generally as cable connector or connector 500. Connector 500 includes a generally C-shaped frame 502 having upper and lower cable receiving channels for receiving cables to be electrically connected. Portions of the C-shaped frame 502 are substantially similar to the C-shaped frames described above with respect to earlier embodiments (e.g., C-shaped frames 102, 302, 402). Accordingly, for reasons of brevity, only a portion of the C-shaped frame 502 for describing the differences is shown. According to the present illustrative embodiment, upper channel 504 is capable of receiving a cable 10. Cable 10 is generally a stranded cable having multiple conductive strands 20 and includes an insulative jacket 22. According to this illustrative embodiment, one or more insulation piercing members 510 extend from C-shaped frame 502 into the upper channel 504. The insulation piercing member 510 is, in this exemplary embodiment, a triangular shaped member extending from the C-shaped frame 502 and includes a piercing tip 505 capable of piercing the insulative jacket 20 of cable 10 when cable 10 is compressed by action of the cam or cam and block arrangements as described above with respect to the previously illustrated embodiments. The piercing tip 505 contacts the electrical wire or wires within cable 10 to create an electrical path between cable 10 and C-shaped frame 502. The piercing member 510 includes a base side 503 that is integrally or monolithically formed into the C-shaped frame 502. It will be appreciated that although not shown, one or more insulation piercing members 510 may also be provided which extend into the lower cable receiving channel.

An electrical cable connector according to another illustrative embodiment of the present disclosure is shown in FIG. 8B and may be referred to generally as cable connector or connector 600. Connector 600 includes a generally C-shaped frame 602 having upper and lower cable receiving channels for receiving cables to be electrically connected. Portions of the C-shaped frame 602 are substantially similar to the C-shaped frames described above with respect to earlier embodiments (e.g., C-shaped frames 102, 302, 402, 502). Accordingly, for reasons of brevity, only a portion of the C-shaped frame 602 for describing the differences is shown. According to the present illustrative embodiment, upper channel 604 is capable of receiving a cable 10. Cable 10 is generally a stranded cable having multiple conductive strands 20 and includes an insulative jacket 22. According to this illustrative embodiment, one or more insulation piercing members 610 extend from C-shaped frame 602 into the upper channel 604. The insulation piercing member 610 is, in this exemplary embodiment, a triangular shaped member extending from the C-shaped frame 602 and includes a piercing tip 605 capable of piercing the insulative jacket 22 of cable 10 when cable 10 is compressed by action of the cam and block described with respect to the previously illustrated embodiments. The piercing tip 605 contacts the electrical wire or wires within cable 10 to create an electrical path between cable 10 and C-shaped frame 602. According to this illustrative embodiment, the piercing member 610 includes a base 603 that is configured and dimensioned to fit within the channel 607 formed in C-shaped frame 602 so that the insulation piercing member 610 is removably attached to the C-shaped frame 602. In particular, the channel 607 extends along at least a portion of the width of the C-shaped frame 602 and forms the mortise portion of a sliding dove-tail type connection joint. The base 603 of the insulation piercing member 610 is tapered to form the tenon or tongue of the sliding dove-tail connection joint. Preferably, there is sufficient friction between the channel 607 and the base 603 so that after the base 603 is inserted into the channel 607, the insulation piercing member 610 remains in position within the channel 607. It will be appreciated that although not shown, one or more insulation piercing members 610 may also be provided which extend into the lower cable receiving channel.

In addition or alternatively, the portion of the one or more blocks (e.g., blocks 108, 110) that contact the cables 10, 12 may include insulation piercing members as described herein. In addition or alternatively, one or more insulation piercing members as described herein may be provided extending into the groove 420 of cam member 440 so that as the cam member 440 is rotated, the insulation piercing members pierce the insulation jacket surrounding the cable (10, 12) being compressed between the groove 420 of cam member 440 and the upper and lower channels 404, 406 of the C-shaped frame 402.

The insulation piercing members as described herein may be formed by, for example, a stamping process, a metal casting process or a machining process and hardened using conventional hardening processes, such as heating and rapidly cooling the insulation piercing member.

The insulation piercing members may come in different shapes and sizes configured and dimensioned to pierce or cut through insulation surrounding electrical wires, such as a cone-shaped member or a member with a pointed tip. Further, the insulation piercing members may include a serrated tip to assist in the piercing through insulation surrounding the electrical wires. The insulation piercing members are preferably made of a hardened material that is sufficient to pierce through insulation surrounding the run conductors. Non-limiting examples of such hardened material include 6000 series aluminium, stainless steel or hardened brass.

The C-shaped frames, blocks and cams may be made of an electrically conductive material that has sufficient rigidity to withstand the forces applied by the cam and blocks against the C-shaped frames when mechanically and electrically connecting the main conductor to a tap conductor. Non-limiting examples of such electrically conductive and rigid materials include aluminum, aluminum alloys, steel, stainless steel, galvanized steel, copper and copper/brass alloys, etc.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. An electrical power connector assembly comprising:
a frame having opposing conductor securing contact sections;
a cam member rotatably mounted to the frame between the opposing conductor securing contact sections; and
a pair of blocks, wherein the pair of blocks are provided between the cam member and conductors to be secured in the opposing conductor securing contact sections and when the cam member is rotated, the pair of blocks press against the conductors securing the conductors in the opposing conductor securing contact sections.

2. The electrical power connector assembly according to claim 1, wherein the cam member comprises an oblong shaft.

3. The electrical power connector assembly according to claim 2, wherein the cam member further comprises a hexagonal shaped head.

4. The electrical power connector assembly according to claim 2, wherein the cam member further comprises a head having a hexagonal shaped hole.

5. The electrical power connector assembly according to claim 2, wherein the cam member further comprises a hexagonal shaped head including a hexagonal shaped hole.

6. The electrical power connector assembly according to claim 1, wherein the cam member further comprises at least one detent.

7. The electrical power connector assembly according to claim 6, wherein the at least one detent comprises 4 detents.

8. The electrical power connector assembly according to claim 1, wherein at least one of the opposing conductor securing contact sections, the cam member, and the pair of blocks further comprise insulation piercing members.

9. An electrical power connector assembly comprising:
a frame having opposing conductor securing contact sections; and
a cam member rotatably mounted to the frame between the opposing conductor securing contact sections,
wherein the cam member includes contact surfaces for contacting the conductors to be secured in the opposing conductor securing contact sections and when the cam member is rotated, the contact surfaces press against the conductors securing the conductors in the opposing conductor securing contact sections.

10. The electrical power connector assembly according to claim 9, wherein the cam member comprises an oblong shaft.

11. The electrical power connector assembly according to claim 10, wherein the cam member further comprises a hexagonal shaped head.

12. The electrical power connector assembly according to claim 10, wherein the cam member further comprises a head having a hexagonal shaped hole.

13. The electrical power connector assembly according to claim 10, wherein the cam member further comprises a hexagonal shaped head including a hexagonal shaped hole.

14. The electrical power connector assembly according to claim 9, wherein the cam member further comprises at least one detent.

15. The electrical power connector assembly according to claim 14, wherein the at least one detent comprises 4 detents.

16. The electrical power connector assembly according to claim 9, wherein at least one of the opposing conductor securing contact sections and the cam member further comprise insulation piercing members.
